(19) United States
(12) Patent Application Publication
(10) Pub. No.: US 2006/0143695 A1
(43) Pub. Date: Jun. 29, 2006

(54) Anonymous Spoof resistant authentication and enrollment methods

(76) Inventor: Amiram Grynberg, Neve Efrayim Monson (IL)

Correspondence Address: AMIRAM GRYNBERG, 24 RIMON ST, NEVE EFRAYIM MONSON, 60190, IL

(21) Appl. No.: 10/905,306

(22) Filed: Dec. 27, 2004

(51) Int. Cl. H04L 9/32

(52) U.S. Cl. 726/4

(57) ABSTRACT

Methods for creating and authenticating a message sent from a client over a communication link to a server comprising the steps of creating a message at client containing client identification data adding to said message a first anti-spoof data element computed as a function of a key derived from a shared secret and communication link attribute data, sending said message from client to server over communication link, verifying at server said anti-spoof data element by computing a verification function of anti-spoof element data, server link attribute data and server key computed from said shared secret related to client. These methods are also used for enrolling clients to an authentication system employing authenticated anonymous client certificates.

### CROSS-REFERENCE TO RELATED APPLICATIONS

Ser. No. 10/905,160

### BACKGROUND OF THE INVENTION

The internet in general and the World Wide Web in particular, help people and organizations connect with each other for business and pleasure. However, the Internet also proves to be a new play media for scamming and fraud.

As more people (users) enter personal and private data into Web forms through web browsers, other parties (attackers) have looked for ways to defraud users and retrieve said personal data using various methods.

In particular, a method called “Phishing” has become popular recently. Using that method, an attacker prepares a bogus web site that resembles a real existing site (cloned site). The attacker then sends an email to a user prompting said user to visit the spoofed web site for important business related to the cloned site. Many times the cloned sites are financial institutions or other organizations where users have accounts with.

Phishing is a special case of what is generally known as man-in-the-middle-attack in the art of cryptography.

A user visiting the spoofed site is asked to enter secret credentials into an online form as part of the ‘identification process’. Since the spoofed site seems similar to a real site the user may be doing business with, users fall into such a trap and provide secret information like passwords, credit card numbers and other related information.

Financial institutions and others are actively looking for solution to this problem. (see http://www.antiphishing.org/ for case studies and working committees, which is incorporated here by reference). In a report issued by Anti Phishing Working Group on May 24, 2004 they say: “Reports of Email Fraud and Phishing Attacks Increase By 180% in April: Up 4,000% Since November”

Several solutions have been proposed to date. In one solution, called “SpoofStick” a software program monitors sites the user is accessing and displays to the user the site's domain name in the browser's title. In another solution called “Web Caller-ID”, a software extension to a browser, performs an analysis of a web site the user is accessing trying to figure out if it's a real one or a fake. The program analyses the structure of the site and its links to try and reach such a determination. However, the most popular approach is offered by companies like Symantec Inc. who use anti virus techniques to filter out emails carrying the original links to the spoofed sites. They use white lists and web analysis techniques.

While the aforementioned techniques help mitigate the problem, they are not fool proof and they delay a user's interaction with a Web site because of the need to check out the structure of the target site during each access.

A foolproof way to protect sites from fraudulent login by attackers is available today to interested parties. Such a technique uses what is known as client certificate to establish a secure two-way communication with a known client. While this method is good, it suffers from deployment problems when sites try to scale it to millions of customers who log into their web sites, as it requires each customer to have a security certificate identifying user and authenticated by a certificate authority. Such requirements are difficult to comply with, both for site owners and for end users accessing these sites. Furthermore, end user cannot keep their anonymity when using authenticated certificates, which makes this option even less desirable to them.

It is therefore, highly desirable to have a solution that would be acceptable to end users, whereby even if attackers have succeeded in luring a victims to their web site, they would not be able to use captured login information to impersonate the victim in front of the real site. Furthermore, it would be advantageous to have a system whereby deployment and enrolment are simple and anonymous.

### SUMMARY OF THE INVENTION

The current invention describes a method for protecting servers from man-in-the-middle attack during an authentication session where the identity of one network node comprising an anonymous client computing device (Client) is being authenticated to another node comprising a server computing device (Server) over a communication link.

In accordance with the present invention, Client communicates to Server, as part of the authentication message and in a tamper proof way, information about a unique characteristic of the communication link between Client and Server. Said information is then checked by Server to verify that said communication link has not been tampered with by a man-in-the-middle attack.

When a message is created at Client, Client adds a Client identification element (if it is not already included) containing client's identity as known to server.

Client then adds anti-spoof element data, computed from key data derived from secret data shared with Server and from a unique communication link attribute data as known to Client.

A Server receiving said message, recreates key data from a shared secret retrieved from storage based on Client's identification element. Server then verifies said anti-spoof element through a verification function of key data and unique communication link attribute data as known to Server.

If Client and Server share the same communication link, then they would both have the same unique communication link attribute data, resulting in said verification to succeed. However, if a man-in-the-middle attacker has intervened, Client and Server would have different views of their respective unique communication link attribute data.

Once, communication link is verified, Client authentication can proceed as usual.

The above authentication method is also embedded as part of an enrollment method for establishing a secure communication channel between Client and Server using anonymous authenticated client certificates.

### BRIEF DESCRIPTIONS OF THE DRAWINGS

no drawings

### DETAILS OF THE INVENTION

The current invention describes a method for protecting servers from a man-in-the-middle attack during an authentication session, where the identity of one network node comprising an anonymous client computing device (Client) is being authenticated to another node comprising a server computing device (Server) over a communication link. Furthermore, this invention introduces a method for enrolling Clients to Servers as part of a successful authentication session.

The term “anonymous” refers to a Client which does not own a digital client certificate that can be authenticated by Server to represent Client. Otherwise, said certificate would be used in establishing a secure two way communication based on an authenticated client certificate and the man-in-the-middle attack becomes a non issue.

Authentication

Generally, during an authentication session, Client sends to Server an authentication message containing Client identifying data and authentication data. Server then verifies that Client identifying data corresponds to authentication data thus authenticating Client and message. However, when a man-in-the-middle attack (Attacker) takes place, the Attacker can create its own message and replay said authentication data to Server and be granted access to Server's resources.

However, in accordance with the present invention, Client communicates to Server, as part of the authentication message and in a tamper proof way, additional information about a unique characteristic of the communication link between Client and Server. Said information is then checked by Server to verify that said communication link has not been tampered with by Attacker.

The term “communication link” refers to any physical or logical link that connects two nodes on a communication network. The only requirement is that such a link would have at least one characteristic (attribute) which is unique, at least during an authentication session.

Said attribute should be unique to either the Client-Server link compared to Client-Attacker link, or the Client-Attacker link compared to Attacker-Server link.

As an example, communication link could be established over an Ethernet network where its unique attribute would be the hardware address (MAC) of the Server's Ethernet card resulting in Client seeing a different address when linked to Server than when linked to Attacker.

Alternatively, a communication link could be established over a TCP/IP network where its unique attribute could be the IP addresses of Client, Server and their port numbers. If Client IP address is used, Server sees a different address when linked to Attacker than when linked to Client. Similarly, if Server IP address is used, Client sees a different address when linked to Server than when linked to Attacker.

However, when proxy devices are used, the address each node sees of its peer node is not the real address of that node but that of the proxy device. (A proxy device may translate addresses between an internal network and an external one). For this invention to work, both Client and Server must know of the same node address. If any of the nodes is hidden behind a proxy device then there are several solutions:

First, since there are two nodes in each communication session, use the address of the other node which is not hidden. Alternatively, a Server usually has a fixed IP address or at least a fixed number of addresses that it might be using. In such a case, a list of these addresses is available to Server. Server then uses each address in turn when it tries to authenticate Client's message until it succeeds. Yet another alternative is to help Client find out its own address by using the service of a trusted server. Client would contact the service and ask it what address it sees on Client's side.

An alternative communication link could be established over a HTTP protocol where Server's domain name is its unique attribute resulting in Client seeing a different address when linked to Server than when linked to Attacker.

A communication link could also be established over a secure TCP/IP channel using the SSL or TLS protocols where its unique attribute could be the Server's certificate when using RSA technique for establishing a session key, resulting in Client seeing a different certificate when linked securely to Server than when linked securely to Attacker.

A unique attribute of any communication link could also be a unique key generated by the Diffie-Hellman (DH), or similar algorithm, for creating encryption keys shared between two nodes over an insecure communication link. In DH, each node contributes to the generated key in a secret and random manner, thus it becomes unique to the two nodes participating in the link. An Attacker cannot take a key generated for the Attacker-Client link and use it in the Attacker-Server link making this key unique to any combination of Client, Server and Attacker. However, it requires a key generation handshake step which may slow down the process.

It should be clear to those skilled in the art of networking and cryptography that other combinations of protocols and attributes could be established meeting the required criteria.

In accordance with the present invention, Client extends an authentication message, by adding custom data elements to make said message spoof resistant.

A first element that Client adds to said message is a Client identifying data, uniquely identifying Client to Server. Such an element is required unless said message already contains one. It could be a user ID or a user's email or any other identifier unique to Server.

A second element that Client adds to said message is a tamper proof anti-spoof data element. Client computes said anti-spoof data element from at least two authentication factors namely, key data (Key) and from one of the unique communication link attribute described above (Link). Link data is determined by Client for the communication link used to communicate with (what Client believes to be) Server.

The “Key” factor is derived from secret data shared with Server. The purpose of Key is to assure Server that Client is indeed the Client identified by its ID (the first element). Key could be a simple password or it could be a seed for generating one time passwords in accordance with one of several well known methods, or it could be any arbitrary function of some shared secret data.

Said shared secret would normally be distributed from Server to Clients as they sign up to its service. It could be delivered by email, telephone or other means. A shared secret text can be entered by a user to Client's software when needed. Client could save an encrypted version of shared secret on some permanent storage. A hardware token device can be used as a storage place as well.

Alternatively, Key is computed inside a hardware token device like a smart card that is distributed from Server to Client or is initialized by entry of a shared secret originated by Server. If Key is computed inside a hardware device, said Key can be copied manually into Client or electronically via a standard port on Client (such as a USB port) accessible to Client.

Multiple shared secrets related to different Servers can be stored at one Client or at a hardware device accessible to Client and only the appropriate shared secret would be used when computing anti-spoof data element for a particular Server. Server's address could be used as a key to retrieve a shared secret matching Server from said storage place.

Computing said tamper proof anti-spoof element from Key and Link entails using a function “F” to output data which is dependent on both Key and Link in a way that makes it impractical for an attacker to recreate Key from said function output or to create another valid anti-spoof data element from a captured anti-spoof element.

Many such functions are available. “F” could be a hash function like MD5 or “F” could be an encryption function like DES with an encryption key derived from Key. “F” could be based on a digital signature standard (DSS) where Link and Key are combined into a message digest and digitally signed.

If “F” is based on DSS, then the public key matching the private key used in computing such a signature must be included with said message as well. Said public key would preferably by part of a digital certificate which is unique to Client but not necessarily identifying Client. An example would be a certificate the subject of which is a serial number of a token device attached to Client. Such a certificate would be authenticated by its manufacturer to be unique and the manufacturer itself would be authenticated by a Root Authority.

When said message is ready, Client sends it to Server via said communication link.

Server uses Client identification data for retrieving a shared secret element associated with said identification data.

To authenticate said message, Server has to verify the two authentication factors that were encoded into said message as an anti-spoof element, namely Key and Link data.

The first factor is Key which is derived from said shared secret. Server has to create its version of Key as part of this verification process. If Key is the shared secret, then this process is simply retrieving from storage a shared secret associated with Client identification data and using it as Key. However, if Client uses a one time password mechanism to generate Key, then Server may have to compute several candidate Keys and test them all because one time passwords have some skew built into their algorithm.

The second factor is Link data. Server determines its view of Link data for the communication link over which said message was received.

In some manifestations of Link data, such as when Server's own IP address is used as Link data, Server may not be able to determine a single Link data. In such a case, Server prepares several candidate Link data.

Assuming that Server has a set of candidate Keys and a set of candidate Link data, the step of verifying the two factors involves two sub-steps.

In the first sub-step, a candidate Key is selected from the set of Keys.

In the second sub-step a verification function “V” is computed over the candidate Key, Link data and the anti-spoof element included in the message.

If the verification function “V” succeeds, then Server authenticates the message. Otherwise, this process is repeated for other candidate combination from the sets of Keys and Link data until verification is successful or the list of candidates is exhausted, in which case, authentication fails.

Said verification function “V” can take on several forms that should match function “F” used by Client to compute the anti-spoof element. Relating to the non exhaustive list of functions mentioned for “F” the following would be valid functions for “V”:

If “F” is a hash function then “V” would comprise comparing anti-spoof element with the output of said hash function over a candidate Key and a candidate Link data. If “F” is an encryption function, “V” would be comparing anti-spoof element with the output of said encryption function over a candidate Key and a candidate Link data. If “F” computes a digital signature over Key and Link data using some private key then “V” would verify such signature over candidate key and a candidate Link data using a public key matching said private key.

Following is one illustrative implementation of the first method for the HTTP protocol of the World Wide Web.

As explained in the background of the invention section, one of the present problems is that of “phishing” attacks. Phishing attacks work on HTTP/HTML level. A web user (User) is presented with a web page that is a clone of a real page of a Server the user wants to communicate with. Usually, User is prompted for a user name and password credentials to facilitate log on to what said User considers as a real site. An attacker receives such login credentials and re-submits them in real-time or delayed—depending on the login technique used to sign on to Server.

In this illustrative embodiment of the current invention, User enters a user name and a password to a web login form. Said password can be static password or dynamic one—using one time password techniques. In an alternative embodiment of the current invention, password field is not required on said form. Instead, said password serves as a shared secret with Server and is used to compute an anti-spoof data element.

An anti-spoof generating program configured to run on Client, requests User to enter a shared secret related to the particular Server which user assumes he or she is communicating with. Said program may save said shared secret in an encrypted form for future use so that it will not require user to re-enter it. Alternatively, User is prompted to enter a one time password.

In an alternative and preferred embodiment, said anti-spoof generating program may read the above User requested data from a hardware device attached to Client via a hardware port or a wireless port accessible to Client instead of requesting it from User.

In yet another alternative embodiment, anti-spoof generating program can generate one time passwords from a shared secret store on Client or a hardware device accessible to Client.

For Client identification data, anti-spoof generating program retrieves user name field from said web from filled out by User. It does so by using form recognition algorithms (see www.google.com). Alternatively, it may use the content of all form fields to represent Client identification data. Yet in another alternative embodiment, Server could send a login form to Client with a well known field name designated to hold Client's identification data and said form filling program could fill-in user name from its own database.

Assuming that Link data factor is the network address of Server, an anti-spoof generating program can retrieve Server's Link data as known to Client in several ways. It can look up the “ACTION” property of the form in the HTML structure of the form, or it can intercept a HTTP POST or HTTP GET messages that result from User clicking on a submit button. Server's address is then resolved from Server's URL by a call to a DNS. Alternatively, Server's URL, in whole or in part, can be used as representing Server's address for computing said anti-spoof data element without the need to translate it to an IP address.

Said anti-spoof generating program computes an anti-spoof data element from Client identification data, said Server address data and from Key data derived from said shared secret. The resulting anti-spoof data element is encoded as a character string compatible with HTML encoding and entered into a field in the login form for that purpose. Alternatively, said encoded anti-spoof data element can be added to an intercepted HTTP POST message. Furthermore, anti-spoof generating program can append encoded anti-spoof data element to a URL when implementing a HTTP GET message for form submission.

Said anti-spoof generating program can be an independent add-on to a standard browser, or it can be part of a browser.

In an alternative embodiment of this invention, form fields are filled by a form filling software configured to also implement the functionality of anti-spoof generating program. This enhanced form filling software can be part of, or an add-on to a browsing program.

When Server receives said HTTP message, it retrieves individual fields from said message. This is a well know task to anyone skilled in the art of computer programming.

Server retrieves Client side anti-spoof data element from HTTP message.

Server retrieves shared secret from storage using Client identification data as an index. Server uses shared secret directly as a Key or computes Key as a one time password from shared secret. If one time password method is used, Server prepares a set of candidate Keys.

Server determines its view of Link data, namely, the set of IP addresses that it uses to communicate with Clients. If an embodiment that uses a URL to represent Server's address is implemented, then usually that URL would be the only address in that set.

Server iterates over all combinations of Keys and addresses from the set of Keys and addresses and for each combination it computes a Server side anti-spoof element data. It then compares said anti-spoof element with Client side anti-spoof element. If elements match, iteration stops and message is authenticated. If no combination matches it fails the authentication.

Enrollment

The methods described above are also embedded as part of an enrollment method of Client to Server.

Enrollment as defined in the context of the current invention is the process of associating at Server, a public key owned by Client and unique to Client (Client Certificate) with a Client identifying data, unique to Server.

Current secure and authenticated communication techniques use authenticated Client Certificates and are well known to those skilled in the art of secure networking. SSL and TLS protocols are representative implementations of such secure and authenticated communication methods. However, a deployment problem prevents the use of these protocols for the masses as each individual User would have to be authenticated by a certification authority (CA) recognized by Server and each User's certificate would have to be associated uniquely with User's records saved on Server. Furthermore, with full client authentication, Users lose their anonymity.

In accordance with the present invention, Client obtains a Client Certificate whereby the certificate is authenticated to be globally unique but it does not contain information globally identifying Client.

Authenticated Certificates can be produced by a trusted issuer of regular client certificates and distributed to Clients using various means that guaranty a unique certificate per Client.

In a preferred embodiment of this invention, Certificates are delivered to Clients inside a hardware token device like a smart card accessible to Client, where the private key related to Certificate is secure and Certificate is authenticated by the manufacturer of said device during the initialization phase of said device to be unique among other Certificates. Since hardware token device can only be associated with a single Client at a time, the unique association of Certificates to Clients is achieved.

Server adds manufacturers of said token devices to its list of trusted CA or alternatively, these manufacturers need to be authorized as CAs by a trusted root authority, so that said Certificates are recognized for secure communication.

In accordance with the present invention, enrollment to Server is achieved with Client being authenticated first, using one of the authentication methods described in this invention.

In a preferred embodiment of this enrollment method, Certificate data is added to authentication message during implementation of one of the Client authentication methods which are the subject of the current invention. Thus, saving a send-receive cycle between Client and Server.

Once authenticated, Server accepts from Client, a Client Certificate representing Client and Server stores said Client Certificate in association with Client identifying data. Alternatively, only a digital digest of said certificate is stored.

Once enrolled, Client logs-in to Server by establishing a secure communication link with Server through one of the available protocols like SSL or TLS. Said protocols can be configured to use a Client Certificate stored on Server and associated with Client via the enrollment process.

Alternatively, Client adds its Certificate to a login form it sends to Server. Server then verifies said Certificate by computing a digest of said Certificate and comparing it to a digest stored in a database and related to Client via Client's identifying data. Once verified, said certificate can be used to further authenticate Client in various ways already well known to those skilled in the art.

In either implementation of this enrollment method, Client can authenticate to multiple independent Servers, exposing a single publicly known digital Certificate. Beyond an initial shared secret, used for authentication, which can be disposed of after enrollment, Client needs to store only non-secret Client identifying data specific to each Server.

What is claimed is:

1. A method for authenticating a Client to Server over a communication link comprising the steps of:
creating a message at Client comprising at least Client identifying data unique to Server;
adding to said message a tamper proof anti-spoof data element computed as a function of at least first key data derived from a secret shared between Client and Server and from first unique communication link attribute data as known to Client;
communicating said message from Client to Server over said communication link;
verifying said anti-spoof data element at Server by computing a verification function of at least second key data derived from said shared secret retrieved by Server and related to said Client identifying data, second unique communication link attribute data as known to Server and said anti-spoof data element;
authenticating Client, as identified by said Client identifying data, at Server, if said verification step is successful.

2. The method of claim 1 wherein the step of verifying said anti-spoof element data at Server further includes the sub-steps of:
deriving at Server a set of key data from said shared secret related to said client identifying data;
determining at Server a set of unique communication link attribute data as known to Server;
selecting a second key data from said set of key data and selecting a second communication link attribute data from said set of communication link attribute data;
verifying said selection by computing a verification function of said selected second key data, said selected second communication link attribute data and said anti-spoof data element;
repeating said selection and verification steps for combinations of members from said set of key data and said set of unique communication link attribute data until a sub verification step is successful or until all possible combinations are exhausted.

3. The method of claim 1 wherein said unique communication link attribute data is a MAC address.

4. The method of claim 1 wherein said unique communication link attribute data is an IP address.

5. The method of claim 4 wherein client's determination of its own IP address is carried out by the following steps:
client sends out a data packet query over a communication link to a trusted server requesting the IP address of client;
trusted server sends back to client a data packet comprising client's IP address as measured by said trusted server;
client retrieves its IP address from said data packet.

6. The method of claim 1 wherein said unique communication link attribute data is a Server's URL.

7. The method of claim 1 wherein said communication link is a secure link whereby a session key is exchanged using public key cryptography and wherein said unique communication link attribute data is one of the public keys participating in said key exchange procedure.

8. The method of claim 1 wherein said unique communication link attribute data is a key generated by Client and Server over said communication link by an algorithm guarantying a key unique to Client-Server link.

9. The method of claim 1 wherein said key data is a one time password newly computed by client and server for each message.

10. The method of claim 9 wherein said client's one time password is computed within a hardware token device, displayed on said token device and entered by a user into client.

11. The method of claim 10 wherein said client's one time password is computed within a hardware token electronically accessible to client.

12. The method of claim 1 further including the steps of:
communicating a client certificate from Client to Server;
associating said certificate with Client identifying data if verification step is successful.

13. The method of claim 12 wherein the step of associating said client certificate means storing said client certificate data in a database accessible to Server and related to Client identifying data.

14. The method of claim 12 wherein the step of associating said client certificate means storing a digest of said client certificate data in a database accessible to Server and related to Client identifying data.

15. The method of claim 12 wherein a private key associated with said client certificate is stored in a hardware device accessible to Client.

16. The method of claim 12 wherein said client certificate is identifiable by an anonymous globally unique identifier and authenticated by a certificate authority to be unique.
